(19) United States
(12) Patent Application Publication
(10) Pub. No.: US 2025/0045671 A1
(43) Pub. Date: Feb. 6, 2025

(54) STRATEGY PLANNING SUPPORT APPARATUS, COMMUNICATION SYSTEM, STRATEGY PLANNING SUPPORT METHOD, AND PROGRAM

(71) Applicant: NIPPON TELEGRAPH AND TELEPHONE CORPORATION, Tokyo (JP)

(72) Inventors: Midori KAWADA, Tokyo (JP); Minako HARA, Tokyo (JP); Masahiro SOTOMA, Tokyo (JP); Xiaoxi ZHANG, Tokyo (JP); Machiko SHINOZUKA, Tokyo (JP)

(73) Assignee: NIPPON TELEGRAPH AND TELEPHONE CORPORATION, Tokyo (JP)

(21) Appl. No.: 18/718,780

(22) PCT Filed: Dec. 17, 2021
(86) PCT No.: PCT/JP2021/046858

§ 371 Date: Jun. 11, 2024

(51) Int. Cl. G06Q 10/0637; G06F 40/268

(52) U.S. Cl. CPC G06Q 10/0637; G06F 40/268

(57) ABSTRACT

An object of the present disclosure is to propose a technology that can allow even non-specialists to easily identify driving forces (DF) in order to support the creation of scenarios in line with the actual situation of a company.

A strategy planning support device of the present disclosure includes: an EPU analysis unit that performs EPU analysis on a word in a social situation survey document by using a frequently occurring word in a financial statement of an organization as a Policy classification term; an uncertainty calculation unit that calculates uncertainty of each classification analyzed by the EPU analysis unit by using a potential Dirichlet allocation method; a relevance calculation unit that detects a predetermined word appearing around the word analyzed by the EPU analysis unit in a specific classification having the highest uncertainty as calculated by the uncertainty calculation unit, and calculates relevance of the predetermined word using a cosine similarity; a determination unit that determines a high-order specific word having a high relevance value calculated by the relevance calculation unit, as an element of each coordinate axis of a driving force; and an output unit that outputs the specific word determined by the determination unit.

### TECHNICAL FIELD

The present invention relates to a strategy planning support device, a communication system, a strategy planning support method, and a program.

### BACKGROUND ART

A number of uncertain events (referred to as “events” hereinafter) that affect people's lives and business activities, such as infectious diseases and climate change, have been identified. For the purpose of planning policies and strategies for coping with such events, the influence of the events is analyzed by creating possible scenarios. In particular, companies are required to analyze the impact of the events on their businesses and disclose information as risks and opportunities, as well as the basis for business strategy planning.

In creating scenarios for corporate strategy planning, it is common practice to survey the factors related to the subject of analysis, establish two axes (DF: Driving Forces) that significantly influence the future of the company, and draw a plurality of scenarios along the DF.

FIG. 11 is a conceptual diagram of scenario creation by general scenario planning. As shown in FIG. 11, “diversity” is set as an element of the X-axis, with the diversity becoming larger toward the + direction and the uniformity becoming larger toward the − direction. In addition, “community network” is set as an element of the Y-axis, with the community network becoming stronger toward the + direction and the community network becoming weaker toward the − direction. In order to make effective use of the scenario, it is important to know what to set each element (word) of the coordinate axis of the DF to.

Conventionally, DFs have been determined manually by experts in the field based on their experience and the like (see NPL 1). In this example, a workshop is held by experts to discuss how a sustainable society should be from a lifestyle perspective, a DF is selected, and scenarios related to a plurality of lifestyles are drawn.

### CITATION LIST

### Non Patent Literature

[NPL 1] Kakuwa Masahiro, 2014, Practice of Scenario Planning, “Shell Style,” Journal of Life Cycle Assessment, Japan, vol. 10, pages 254-260
<https://www.nies.go.jp/kanko/news/28/28-2/28-2-02.html>

### SUMMARY OF INVENTION

### Technical Problem

However, conventional scenario creation requires expertise in the selection of DFs and time-consuming information analysis. Furthermore, in order to apply the scenario creation method to strategy planning for an organization such as a company, it is necessary to reflect the situation of the company in addition to knowledge of the subject of analysis.

The present invention was made in view of the above, and an object thereof is to propose a technology that can allow even non-specialists to easily identify driving forces in order to support the creation of scenarios for corporate strategy planning in line with the actual situation of the company.

### Solution to Problem

In order to solve the above problems, an invention according to claim 1 is a strategy planning support device for supporting strategy planning of an organization, including: an EPU analysis unit that performs EPU analysis on a word in a social situation survey document by using a frequently occurring word in a financial statement of the organization as a Policy classification term; an uncertainty calculation unit that calculates uncertainty of each classification analyzed by the EPU analysis unit by using a potential Dirichlet allocation method; a relevance calculation unit that detects a predetermined word appearing around the word analyzed by the EPU analysis unit in a specific classification having the highest uncertainty as calculated by the uncertainty calculation unit, and calculates relevance of the predetermined word using a cosine similarity; a determination unit that determines a high-order specific word having a high relevance value calculated by the relevance calculation unit, as an element of each coordinate axis of a driving force; and an output unit that outputs the specific word determined as the element by the determination unit.

### Advantageous Effects of Invention

As described above, according to the present invention, since the creation of scenarios for corporate strategy planning in line with the actual situation of the company is supported, the present invention can achieve the effect that even non-specialists can easily identify driving forces.

### BRIEF DESCRIPTION OF DRAWINGS

FIG. 1 is a schematic diagram of a communication system.

FIG. 2 is a hardware configuration diagram of a strategy planning support device and a communication terminal according to an embodiment.

FIG. 3 is a functional configuration diagram of the strategy planning support device.

FIG. 4 is a flowchart showing processing of setting up a driving force when creating a possible future scenario for corporate strategy planning.

FIG. 5 is a diagram showing a breakdown of frequently occurring words in a financial statement of Company B.

FIG. 6 is a diagram showing a survey content in a social situation survey document.

FIG. 7 is a diagram showing a survey result in the social situation survey document.

FIG. 8 is a diagram showing a breakdown of frequently occurring words in a document of Country A related to post-Covid lifestyle changes.

FIG. 9 is a diagram showing a list of EPU-related words.

FIG. 10 is a conceptual diagram of scenario creation by scenario planning according to the present embodiment.

FIG. 11 is a conceptual diagram of scenario creation by general scenario planning.

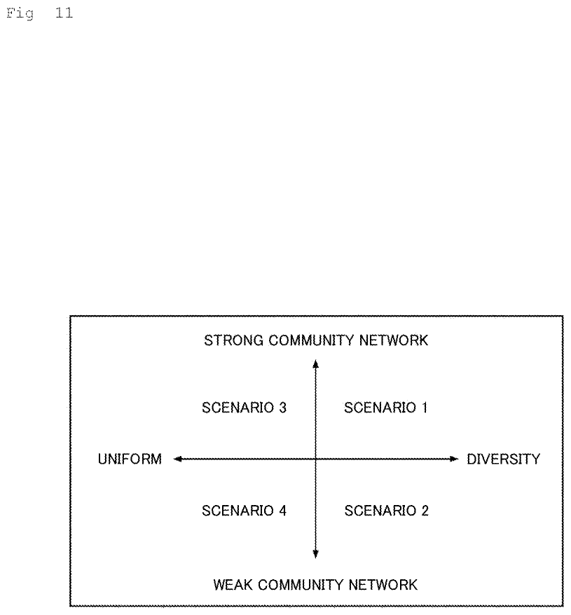

### DESCRIPTION OF EMBODIMENTS

Embodiments of the present invention will be described below with reference to the drawings.

### [System Configuration of Embodiment]

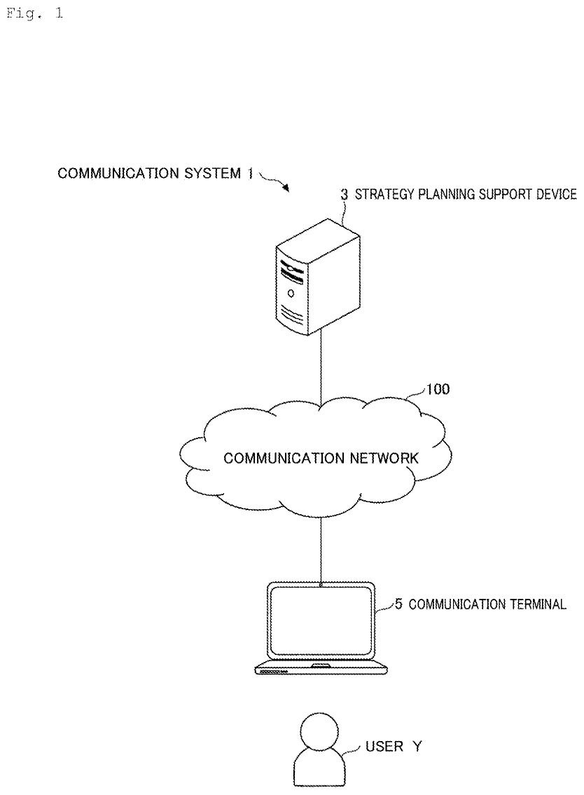

First, an overview of a configuration of a communication system according to the present embodiment will be described with reference to FIG. 1. FIG. 1 is a schematic diagram of a communication system according to an embodiment of the present invention.

As shown in FIG. 1, a communication system 1 of the present embodiment is constructed by a strategy planning support device 3 and a communication terminal 5. The communication terminal 5 is managed and used by a user Y.

Furthermore, the strategy planning support device 3 and the communication terminal 5 can communicate via a communication network 100 such as the Internet. The form of connection of the communication network 100 may be either wireless or wired.

The strategy planning support device 3 is composed of one or more computers. When the strategy planning support device 3 is composed of a plurality of computers, the strategy planning support device 3 may be referred to as “strategy planning support device” or “strategy planning support system.”

The strategy planning support device 3 is a device for supporting strategy planning of a company by setting a DF (driving force) used for creating a scenario of strategy planning of an organization such as a company. Examples of organizations include, in addition to companies, incorporated associations, NPOs (Non-Profit Organizations), and NGOs (Non-Governmental Organizations).

The communication terminal 5 is a computer, and FIG. 1 shows a laptop as an example. In FIG. 1, the user Y operates the communication terminal 5. The strategy planning support device 3 may perform processing independently without using the communication terminal 5.

### [Hardware Configuration of Strategy Planning Support Device and Communication Terminal]

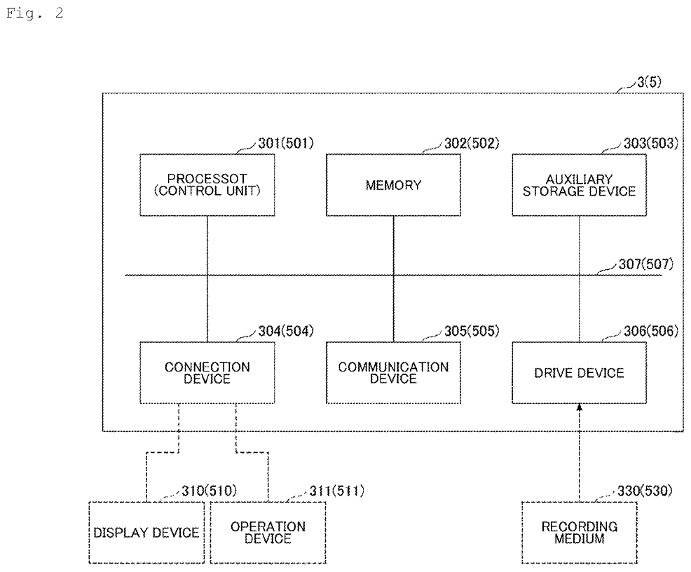

Next, a hardware configuration of the strategy planning support device 3 and the communication terminal 5 will be described with reference to FIG. 2. FIG. 2 is a hardware configuration diagram of the strategy planning support device and the communication terminal according to the present embodiment. As shown in FIG. 2, the strategy planning support device 3 includes a processor 301, a memory 302, an auxiliary storage device 303, a connection device 304, a communication device 305, and a drive device 306. Each piece of hardware constituting the strategy planning support device 3 is interconnected via a bus 307.

The processor 301 serves as a control unit for controlling the entire strategy planning support device 3 and has various computing devices such as a CPU (Central Processing Unit). The processor 301 reads various programs onto the memory 302 and executes the programs. The processor 301 may include a GPGPU (General-purpose computing on graphics processing unit).

The memory 302 has main storage devices such as a ROM (Read Only Memory) and a RAM (Random Access Memory). The processor 301 executes various programs read out on the memory 302, to realize various functional units described below.

The auxiliary storage device 303 stores various programs and various types of information used when the various programs are executed by the processor 301 (financial statement of Company B, social situation survey document, and the like to be described below).

The connection device 304 is a connection device for connecting an external device (e.g., a display device 310, an operation device 311) and the strategy planning support device 3.

The communication device 305 is a communication device for transmitting/receiving various types of information to and from other devices.

The drive device 306 is a device for setting a recording medium 330. The recording medium 330 mentioned herein includes a medium for optically, electrically or magnetically recording information, such as a CD-ROM (Compact Disc Read-Only Memory), a flexible disk, and a magneto-optical disk. The recording medium 330 may include a semiconductor memory for electrically recording information, such as a ROM (Read Only Memory) and a flash memory.

The various programs installed in the auxiliary storage device 303 are installed, for example, when the distributed recording medium 330 is set in the drive device 306 and the various programs recorded on the recording medium 330 are read out by the drive device 306. Alternatively, the various programs installed in the auxiliary storage device 303 may be installed by being downloaded from the network via the communication device 305.

FIG. 2 shows the hardware configuration of the communication terminal 5, but since each configuration is the same except that the code has changed from 300 to 500, these explanations are omitted.

### [Functional Configuration of Strategy Planning Support Device]

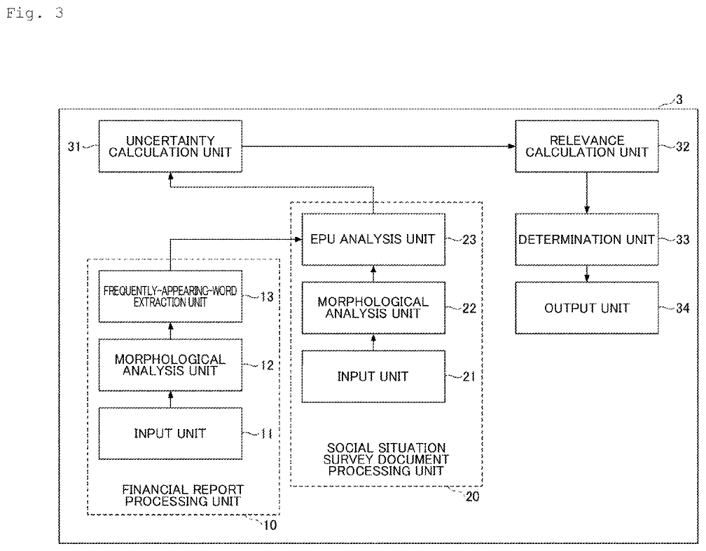

Next, a functional configuration of the strategy planning support device will be described with reference to FIG. 3. FIG. 3 is a functional configuration diagram of the strategy planning support device according to an embodiment of the present invention.

In FIG. 3, the strategy planning support device 3 includes a financial report processing unit 10, a social situation survey document processing unit 20, an uncertainty calculation unit 31, a relevance calculation unit 32, a determination unit 33, and an output unit 34. These units are functions realized by commands from the processor 301 shown in FIG. 2 on the basis of the programs described above.

Further, the financial report processing unit 10 includes an input unit 11, a morphological analysis unit 12, and a frequently-occurring-word extraction unit 13. The social situation survey sentence processing unit 20 includes an input unit 21, a morphological analysis unit 22, and an EPU analysis unit 23.

Of these units, the input unit 11 inputs data indicating a social situation survey document from the auxiliary storage device 303 or the like. The morphological analysis unit 12 extracts a word by performing morphological analysis on data of a financial statement input by the input unit 11. The frequently-occurring-word extraction unit 13 counts the number of the same word related to the current business field or future prospects of an organization that is extracted by the morphological analysis unit 12, and thereby extract a frequently-occurring word that appears a predetermined number of times or more (for example, five times). For example, in a case where two identical words appear in the financial statement, the frequently-occurring-word extraction unit 13 counts the same word twice.

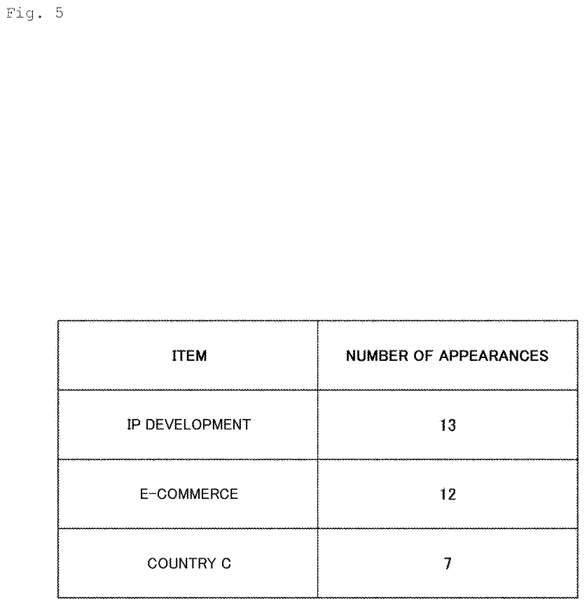

The input unit 21 inputs data indicating a social situation survey document from the auxiliary storage device 303 or the like. The morphological analysis unit 22 extracts a word by performing morphological analysis on the data of the social situation survey document input by the input unit 21. The EPU analysis unit 23 uses the frequently occurring word (see FIG. 5) acquired from the frequently-occurring-word extraction unit 13, as a term of a Policy classification among three classifications of a policy uncertainty index EPU (Economy, Policy, Uncertainty) (by putting the word in a Policy dictionary), and thereby performs EPU analysis on the word extracted by the morphological analysis unit 22. The morphological analysis unit 12 and the morphological analysis unit 22 may be the same or different.

Here, examples of the words included in “Economy” include “economy,” and “economic climate.” Examples of the words included in “Policy,” include “production,” “demand,” “supply,” “profit,” and other words (terms) related to a corporate policy. Furthermore, examples of the words included in “Economy” include “ambiguous,” “uncertain,” “indeterminate,” and “anxious.”

Then, the uncertainty calculation unit 31 uses a potential Dirichlet allocation method (LDA) (see reference document 1) to calculate an uncertainty U of each classification (Economy, Policy, Uncertainty) analyzed by the EPU analysis unit 23.

### <Reference Document 1>

Andres Azqueta-Gavaldon, 2017. “Developing news-based Economic Policy Uncertainty index with unsupervised machine learning”, Economics Letters, Volume 158.

The relevance calculation unit 32 detects a predetermined word appearing around a word used in EPU analysis (e.g., “production,” “demand,” “IP development”) in an EPU classification with the highest uncertainty U based on t calculation by the uncertainty calculation unit 31, and calculates relevance of the predetermined word by using a cosign similarity (see reference document 2).

### <Reference Document 2>

https://www.cse.kyoto-su.ac.jp/˜g0846020/keywords/cosinSimilarity.html

The determination unit 33 analyzes a word group having high relevance, and determines a predetermined word with high relevance as an element of each coordinate axis of the driving force.

The output unit 34 outputs, for example, each piece of data of the word “on-line” and the word “relocate” as an element of each coordinate axis of the driving force. As an output method, data of a word as the driving force is transmitted to the communication terminal 5, displayed, or printed.

### [Processing or Operation of Embodiment]

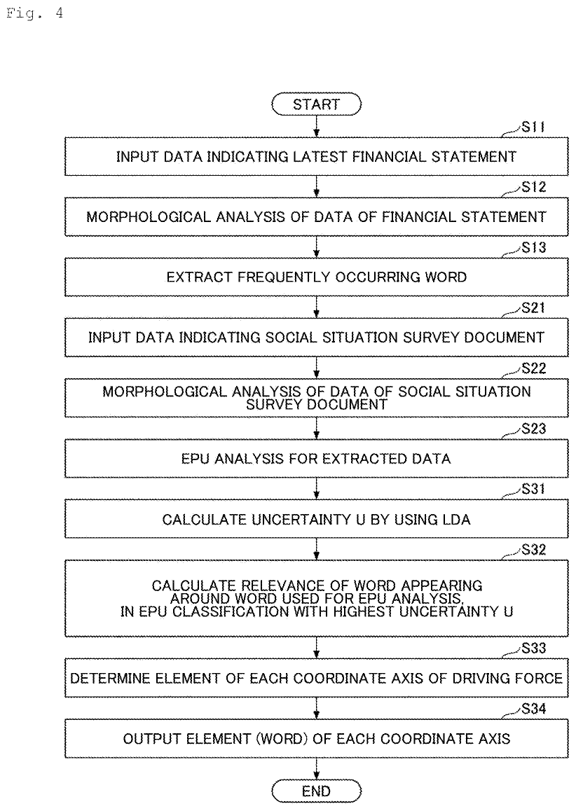

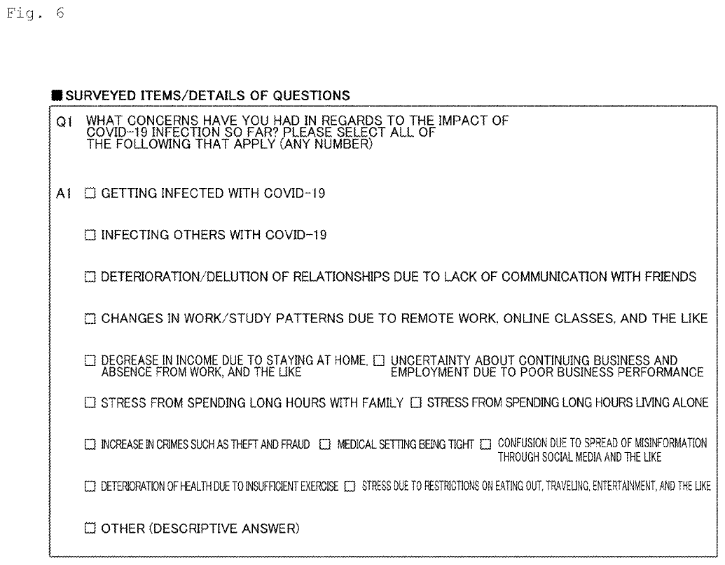

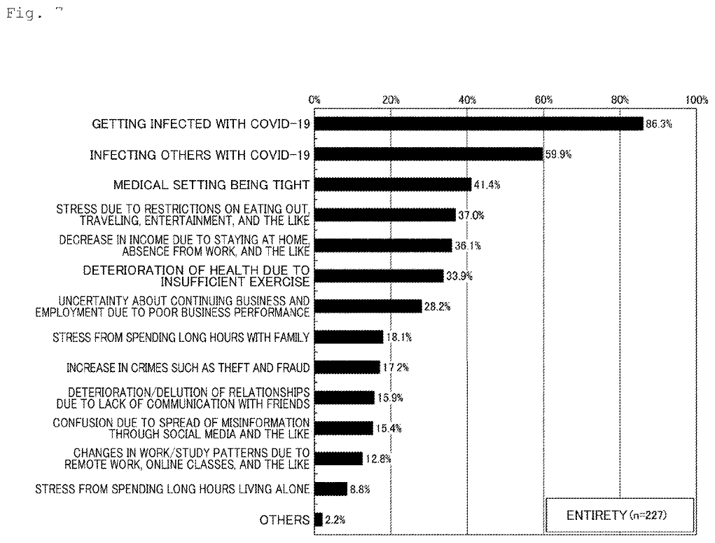

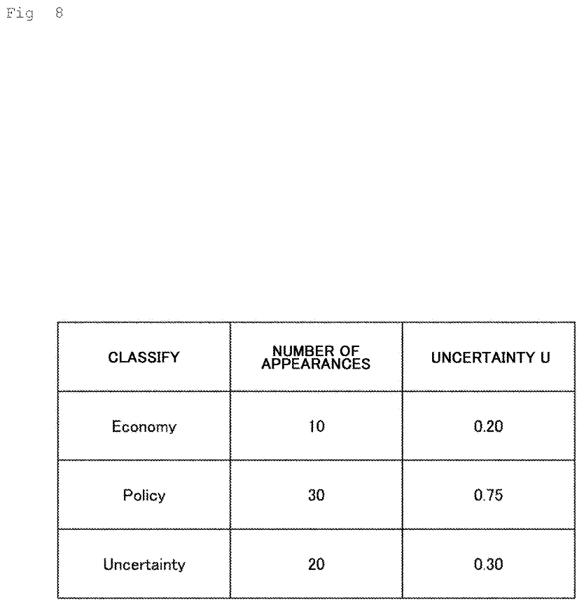

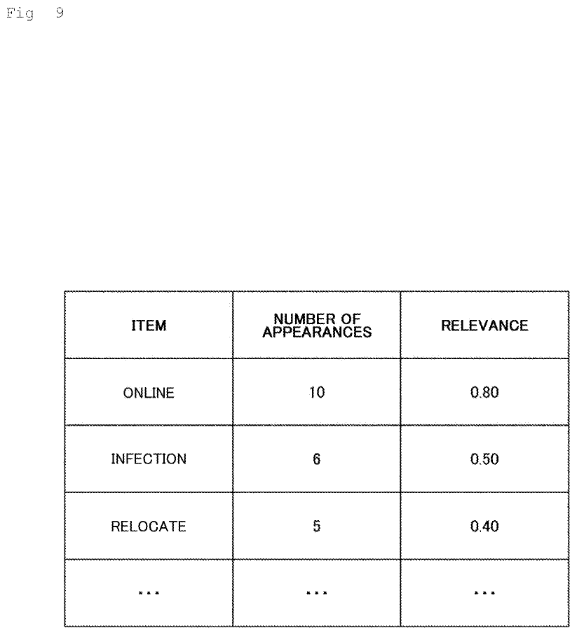

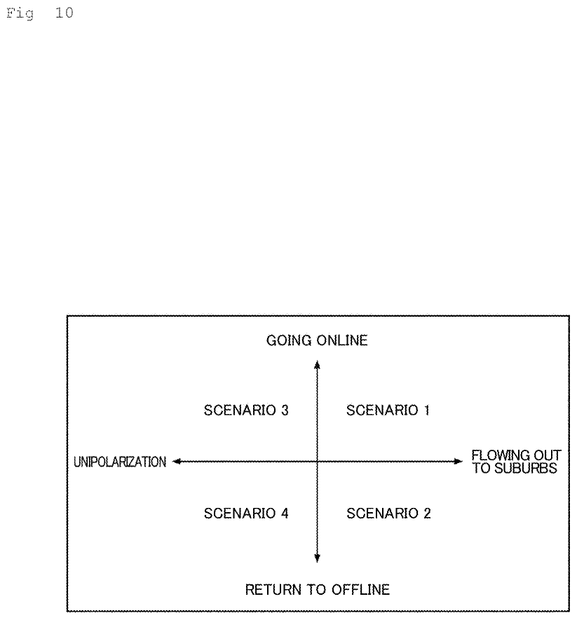

The processing or operation of the present embodiment will be described next in detail with reference to FIGS. 4 to 10. FIG. 4 is a flow chart showing processing for setting a driving force when a scenario which may occur in the future is created for corporate strategy planning. FIG. 5 is a diagram showing a breakdown of frequently occurring words in a financial statement of Company B. FIG. 6 is a diagram showing a survey content in a social situation survey document. FIG. 7 is a diagram showing a survey result in the social situation survey document. FIG. 8 is a diagram showing a breakdown of frequently occurring words in a document of Country A related to post-Covid lifestyle changes. FIG. 9 is a diagram showing a list of EPU-related words. FIG. 10 is a conceptual diagram of scenario creation by scenario planning according to the present embodiment.

As shown in FIG. 4, first, at a command from the communication terminal 5 by the user Y, the input unit 11 inputs data indicating the most recent financial statement of a predetermined organization (in this case, Company B in Country A) (S11). Then, the morphological analysis unit 12 extracts words by morphological analysis of the data of the financial statement input by the input unit 11 (S12). Next, the frequently-occurring-word extraction unit 13 extracts frequently occurring words by counting the number of the same words based on the words extracted by the morphological analysis unit 12 (S13). Specifically, the frequently-occurring-word extraction unit 13 counts the number of the same words extracted by the morphological analysis unit 12 that are related to the current business field or future prospects of the organization (in this case, Company B), to extract frequently occurring words that appear more than a predetermined number of times (for example, five times). For example, as shown in FIG. 5, the same word “IP development,” which appears thirteen times, the same word “E-commerce,” which appears twelve times, and the same word “country C,” which appears seven times, are extracted.

Next, the input unit 21 inputs data indicating a social situation survey document shown in FIGS. 6 and 7 (S21). Then, the morphological analysis unit 22 extracts words by morphological analysis of the data of the social situation survey document input by the input unit 21 (S22). Next, the EPU analysis unit 23 performs EPU analysis on the words extracted by the morphological analysis unit 22 by using the frequently occurring words (see FIG. 5) acquired from the frequently-occurring-word extraction unit 13, as terms in the Policy classification out of the three EPU (Economy, Policy, Uncertainty) classifications (by placing the terms in the Policy dictionary) (S23). For example, the EPU analysis determines the number of occurrences of a word for each EPU classification, as shown in the two columns on the left-hand side of FIG. 8.

Next, the uncertainty calculation unit 31 calculates an uncertainty U for each classification (Economy, Policy, Uncertainty) analyzed by the EPU analysis unit 23 by using a potential Dirichlet allocation method (LDA) (see reference document 1) (S31). As a result, the uncertainty U for each EPU classification is calculated as shown in, for example, the rightmost column 1 of FIG. 8.

Next, the relevance calculation unit 32 detects predetermined words that appear around the words used in the EPU analysis (e.g., “production,” “demand,” “IP development”) in a specific classification of the EPU with the highest uncertainty U as calculated by the uncertainty calculation unit 31, and calculates the relevance of the predetermined words by using the cosine similarity described above (S32). Thus, as shown in FIG. 9, for example, the number of occurrences and relevance are calculated for each of the predefined words (e.g., “online,” “infectious disease,” “relocate”) that appear around the words used in the EPU analysis, as the EPU-related words.

Next, the determination unit 33 analyzes the group of words with high relevance values calculated by the relevance calculation unit 32, and determines specific words with the highest relevance values as elements of each coordinate axis of the driving force (S33). The output unit 34 then outputs the data for each specific word, e.g., the word “online” and the word “relocate,” as elements of each coordinate axis of the driving force.

Therefore, as shown in FIG. 10, in scenario creation through scenario planning, “online” is set as an element of the Y-axis, with the value of going online increasing toward the + direction, and the value of going back offline increasing toward the − direction. Also, “relocate” is set as an element on the X-axis, with the number of outflows to the suburbs increasing toward the + direction and the number of unipolarities (in urban areas) increasing toward the − direction. Thus, in scenario creation through scenario planning, the word “offline,” which means the opposite of “online,” is set, and “unipolarization,” which is contrasted in social life with “outflow to the suburbs,” is set in relation to “relocate.”

### Effects of Embodiment

As described above, according to the present embodiment even non-specialists can easily identify driving forces in order to support the scenario creation in line with the actual conditions of a company.

### [Supplementary Notes]

The present invention is not limited to the embodiments described above, and may have configurations or processing (operations) described below.

(1) The strategy planning support device 3 can also be implemented by a computer and a program, and the program can be recorded on a (non-temporary) recording medium or provided through the communication network 100.

(2) In communication between the strategy planning support device 3 and the communication terminal 5, another device (server, router, etc.) may relay data.

(4) Although a laptop is shown as an example of the communication terminal 5 in the foregoing embodiments, the communication terminal 5 is not limited thereto and may be, for example, a desktop computer, a tablet terminal, a smartphone, a smartwatch, a car navigation device, a refrigerator, a microwave, or the like.

(5) A neural network may be used in at least one of the calculations executed by the uncertainty calculation unit 31 and the relevance calculation unit 32 described above.

### REFERENCE SIGNS LIST

1 Communication system
3 Strategy planning support device
5 Communication terminal
10 Financial report processing unit
11 Input unit
12 Morphological analysis unit (example of first morphological analysis unit)
13 Frequently-occurring-word extraction unit
20 Social situation survey document processing unit
21 Input unit
22 Morphological analysis unit (example of second morphological analysis unit)
23 EPU analysis unit
31 Uncertainty calculation unit
32 Relevance calculation unit
33 Determination unit
34 Output unit

1. A strategy planning support device for supporting strategy planning of an organization, comprising:
an EPU analysis unit that performs EPU analysis on a word in a social situation survey document by using a frequently occurring word in a financial statement of the organization as a Policy classification term;
an uncertainty calculation unit that calculates uncertainty of each classification analyzed by the EPU analysis unit by using a potential Dirichlet allocation method;
a relevance calculation unit that detects a predetermined word appearing around the word analyzed by the EPU analysis unit in a specific classification having the highest uncertainty as calculated by the uncertainty calculation unit, and calculates relevance of the predetermined word using a cosine similarity;
a determination unit that determines a high-order specific word having a high relevance value calculated by the relevance calculation unit, as an element of each coordinate axis of a driving force; and
an output unit that outputs the specific word determined as the element by the determination unit.

2. The strategy planning support device according to claim 1, further comprising:
a frequently-occurring-word extraction unit that extracts the frequently occurring word that appears a predetermined number of times or more by counting the same word in the financial statement of the organization.

3. The strategy planning support device according to claim 2, further comprising:
a first morphological analysis unit that extracts a word by performing morphological analysis on data of the financial statement of the organization,
wherein the frequently-occurring-word extraction unit extracts the frequently occurring word by counting the same word based on the word extracted by the first morphological analysis unit.

4. The strategy planning support device according to claim 3, wherein the same word is a word related to a current business field or future prospects of the organization.

5. The strategy planning support device according to claim 1, further comprising:
a second morphological analysis unit that extracts a word by performing morpheme analysis on data of the social situation survey document,
wherein the EPU analysis unit performs EPU analysis on the word in the social situation survey document extracted by the second morphological analysis unit.

6. The strategy planning support device according to claim 1, further comprising
a communication terminal that receives data of the specific word output from the strategy planning support device.

7. A strategy planning support method for supporting strategy planning of an organization comprising:
an EPU analysis step of performing EPU analysis on a word in a social situation survey document by using a frequently occurring word in a financial statement of the organization as a Policy classification term;
an uncertainty calculation step of calculating uncertainty of each classification analyzed in the EPU analysis step by using a potential Dirichlet allocation method;
a relevance calculation step of detecting a predetermined word appearing around the word analyzed in the EPU analysis step in a specific classification having the highest uncertainty as calculated in the uncertainty calculation step, and calculating relevance of the predetermined word using a cosine similarity;
a determination step of determining a high-order specific word having a high relevance value calculated in the relevance calculation step, as an element of each coordinate axis of a driving force; and
an output step of outputting the specific word determined as the element in the determination step.

8. (canceled)

9. The strategy planning support method according to claim 7, further comprising:
the frequently occurring word that appears a predetermined number of times or more is executed by counting the same word in the financial statement of the organization.

10. The strategy planning support method according to claim 9, further comprising:
a word is extracted by performing morphological analysis on data of the financial statement of the organization,
wherein the frequently occurring word is extracted by counting the same word based on the word extracted.

11. The strategy planning support method according to claim 10, wherein the same word is a word related to a current business field or future prospects of the organization.

12. The strategy planning support method according to claim 7, further comprising:
a word is extracted by performing morpheme analysis on data of the social situation survey document,
wherein the EPU analysis is performed on the word in the social situation survey document extracted by the second morphological analysis unit.

13. The strategy planning support method according to claim 7, further comprising
data of the specific word output is received from the strategy planning support device.

14. A computer-readable non-transitory recording medium storing computer-executable program instructions that when executed by a processor cause a computer to execute a strategy planning support program comprising:
an EPU analysis step of performing EPU analysis on a word in a social situation survey document by using a frequently occurring word in a financial statement of the organization as a Policy classification term;
an uncertainty calculation step of calculating uncertainty of each classification analyzed in the EPU analysis step by using a potential Dirichlet allocation method;
a relevance calculation step of detecting a predetermined word appearing around the word analyzed in the EPU analysis step in a specific classification having the highest uncertainty as calculated in the uncertainty calculation step, and calculating relevance of the predetermined word using a cosine similarity;
a determination step of determining a high-order specific word having a high relevance value calculated in the relevance calculation step, as an element of each coordinate axis of a driving force; and
an output step of outputting the specific word determined as the element in the determination step.

15. The strategy planning support program according to claim 14, further comprising:
the frequently occurring word that appears a predetermined number of times or more is executed by counting the same word in the financial statement of the organization.

16. The strategy planning support program according to claim 15, further comprising:
a word is extracted by performing morphological analysis on data of the financial statement of the organization,
wherein the frequently occurring word is extracted by counting the same word based on the word extracted.

17. The strategy planning support program according to claim 16, wherein the same word is a word related to a current business field or future prospects of the organization.

18. The strategy planning support program according to claim 14, further comprising:
a word is extracted by performing morpheme analysis on data of the social situation survey document,
wherein the EPU analysis is performed on the word in the social situation survey document extracted by the second morphological analysis unit.

19. The strategy planning support program according to claim 14, further comprising
data of the specific word output is received from the strategy planning support device.
